(19) United States
(12) Patent Application Publication
(10) Pub. No.: US 2013/0238229 A1
(43) Pub. Date: Sep. 12, 2013

(54) TRAFFIC VOLUME ESTIMATION

(71) Applicants: Andrew Lundquist, Owasso, OK (US); Greg Hines, Claremore, OK (US)

(72) Inventors: Andrew Lundquist, Owasso, OK (US); Greg Hines, Claremore, OK (US)

(21) Appl. No.: 13/417,857

(22) Filed: Mar. 12, 2012

(51) Int. Cl. G08G 1/00

(52) U.S. Cl. 701/118; 701/117

(57) ABSTRACT

A computer-implemented method of estimating traffic data for a location, the method being implemented in a computer comprising a memory in communication with a processor. The method comprises receiving, as input to the processor, first data associated with the location selecting, by the processor, one of a plurality of models based upon the first data associated with the location receiving, as input to the processor, second data associated with the location and estimating traffic data for the location based upon the selected model and the second data.

### TECHNICAL FIELD

The present invention relates to traffic volume estimation.

### BACKGROUND OF THE INVENTION

In many industries, traffic data is useful in decision making processes. For example, retailers and other consumer-based businesses often rely on traffic data when making decisions on where to locate new facilities.

Traffic data is often obtained by manual collection whereby an observer is employed to record the number of vehicles passing a particular location. However it will be appreciated that such manual collection can be expensive as an observer has to be employed for as long as it is desired to collect traffic data. Additionally it is generally not possible to employ an observer to be present at the location at all times and on all days and such manually obtained traffic data is therefore often incomplete.

Recently automated traffic sensors that count passing vehicles electronically have been used. Such automated traffic sensors have the advantage that they are able to count traffic data continuously. However such automated traffic sensors are costly to implement and maintain and will often have periods where maintenance is required during which traffic data is not collected. In order to mitigate some of the problems with cost, it is common for traffic data to be collected for a particular location relatively infrequently, such that limited resources can be used to collect data for a number of different locations.

A commonly used traffic data metric is Annual Average Daily Traffic (AADT). It will be appreciated that given that traffic data is rarely collected continuously throughout the year at any particular location, some processing of the data collected for a location is typically used to estimate AADTs for particular locations for the year in which the data was collected. However there remains a need for improvements in traffic data estimation systems and methods.

### SUMMARY OF THE INVENTION

It is an object of the invention to provide improvements in systems and methods for estimating traffic data.

According to a first aspect of the invention there is provided a computer-implemented method of estimating traffic data for a location, the method being implemented in a computer comprising a memory in communication with a processor. The method comprises receiving, as input to the processor first data associated with the location and selecting, by the processor, one of a plurality of models based upon the first data associated with the location. Second data is received, as input to the processor, and traffic data is estimated for the location, by the processor, based upon the selected model and the second data associated with the location.

The inventors have realised that by selecting one of a plurality of models based upon data associated with a location for which traffic data is to be estimated, traffic data estimation for the location is improved.

The traffic data may be an indication of a total number of vehicles passing that location in a particular time period.

The first data associated with the location may comprise a property of the location. The property of the location may be a population density associated with the location. The property of the location may additionally or alternatively include a traffic count of the location. Selecting one of a plurality of models may comprise determining whether the first data associated with the location satisfies a predetermined criterion.

That is, a predetermined criterion may be associated with each of the plurality of models, and one of the plurality of models may be selected based upon the predetermined criteria associated with the plurality of models, for example by comparing the first data associated with the location with the predetermined criteria. In this way, locations are effectively divided into a plurality of different categories based upon properties of the locations and it has been found that dividing locations into different categories for estimating traffic data provides improved traffic data estimation for a location.

The second data may be selected from a plurality of data items associated with the location and may be, for example, selected based upon the selected model. For example, a plurality of data items associated with the location may be stored and each of the plurality of models may have some or all of the stored data items as parameters. A subset of those data items may therefore be selected based upon the parameters of the selected model.

It has been found that different data is useful for estimating traffic data depending upon the location. That is, whilst a large amount of data generally related to traffic data may be available for a location, not all of that data may be useful in estimating traffic data for that location and selecting a subset of available data for estimating traffic data provides improved traffic data estimation.

The second data may comprise a traffic count of the location. The traffic count may be a historical traffic count that was measured at the location, for example using an observer or a traffic sensor located at the location. The traffic count of the location may be a most recent traffic count and/or one or more historical traffic counts other than a most recent traffic count of the location.

Additionally or alternatively the second data may comprise an indication of a population for the location. The population may be a population selected from the group consisting of: a total population; a Hispanic population; an adult population; an employed population; and a retail employee population.

The indication of a population for the location may comprise an indication of the population in a current year and/or in a previous year. Additionally or alternatively the second data may comprise a change between a current year population and a previous year population. The previous year may for example be a previous year associated with a historical traffic count used in the traffic count estimation for the location and additionally included in the received second data.

The second data may comprise an indication of vehicle ownership. The indication of vehicle ownership may be an indication of a total number of vehicles registered to addresses at the location or an average number of vehicles per household at the location.

Where a second data item required for traffic data estimation for a location is not available, an indication may be output that traffic data estimation is not possible.

Each of the first and second data items may be determined based upon an area defined relative to the location, for example centred on the location. The area may be different for different ones of the data items.

Aspects of the invention can be implemented in any convenient form. For example computer programs may be provided to carry out the methods described herein. Such computer programs may be carried on appropriate computer readable media which term includes appropriate non-transient tangible storage devices (e.g. discs). Aspects of the invention can also be implemented by way of appropriately programmed computers and other apparatus.

### BRIEF DESCRIPTION OF THE DRAWINGS

Embodiments of the invention will now be described, by way of example, with reference to the accompanying drawings in which:

FIG. 1 is a schematic illustration of a traffic count estimation system;

FIG. 1A is a schematic illustration of a computer of the arrangement of FIG. 1;

FIG. 2 is a flowchart showing processing carried out in selecting a model of a plurality of models; and

FIG. 3 is a flowchart showing processing carried out in determining a traffic estimate.

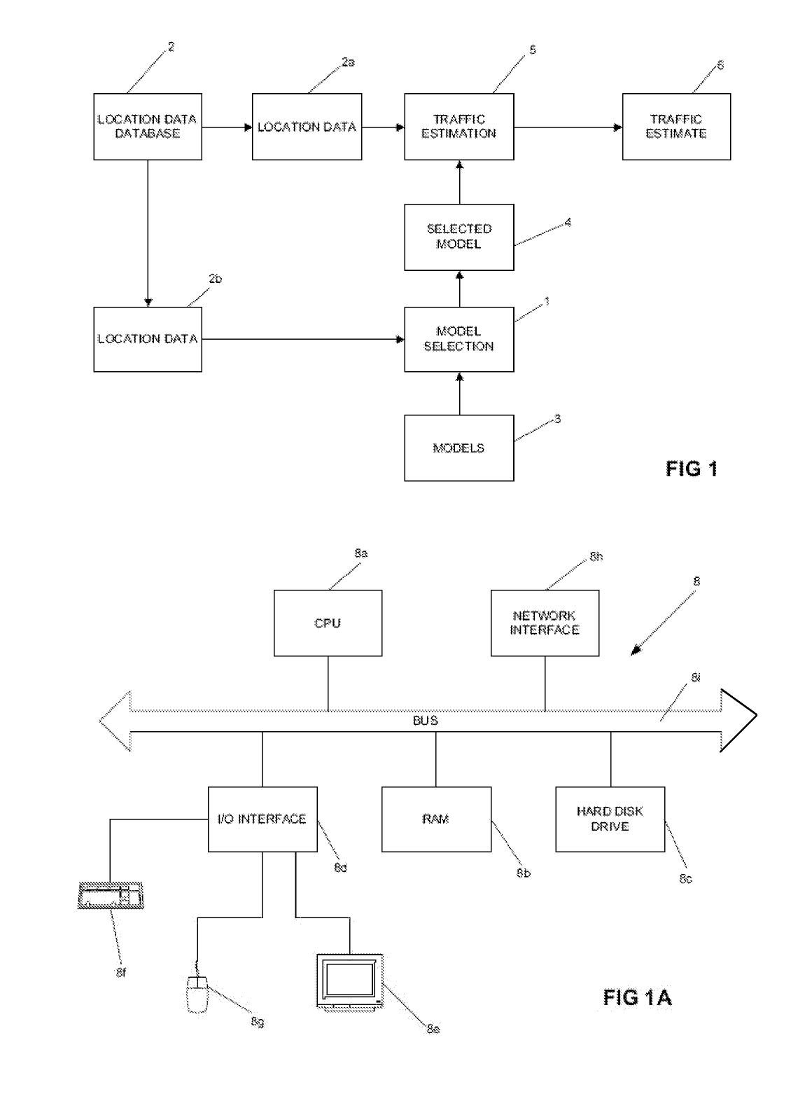

Referring to FIG. 1 a traffic count estimation system is shown. A model selection module 1 takes as input location data 2a from a location database 2, the location data 2a being associated with a particular location for which it is desirable to estimate traffic volume, together with a plurality of models 3. The model selection module 1 processes the location data 2a and the plurality of models 3 and outputs a selected model 4 of the plurality of models 3 based upon the location data 2a. A traffic estimation module 5 receives from the location data database location data 2b including measured traffic data for the particular location and the selected model 4 and outputs a traffic estimate 6 providing an estimate of traffic volume at the particular location.

FIG. 1A shows a computer 8 suitable for carrying out the processing of the invention. It can be seen that the computer comprises a CPU 8a which is configured to read and execute instructions stored in a volatile memory 8b which takes the form of a random access memory. The volatile memory 8b stores instructions for execution by the CPU 8a and data used by those instructions. For example, in use, the location data 2, measured traffic count 6 and models 3 may be stored in the volatile memory 8b.

The computer 8 further comprises non-volatile storage in the form of a hard disc drive 8c. The location data 2, measured traffic count 6 and models 3 may be stored on the hard disc drive 8c. The computer 8 further comprises an I/O interface 8d to which are connected peripheral devices used in connection with the computer 8. More particularly, a display 8e is configured so as to display output from the computer 8. The display 8e may, for example, display the traffic estimate 7. Input devices are also connected to the I/O interface 8d. Such input devices include a keyboard 8f and a mouse 8g which allow user interaction with the computer 8. A network interface 8h allows the computer 8 to be connected to an appropriate computer network so as to receive and transmit data from and to other computing devices. The CPU 8a, volatile memory 8b, hard disc drive 8c, I/O interface 8d, and network interface 8h, are connected together by a bus 8i.

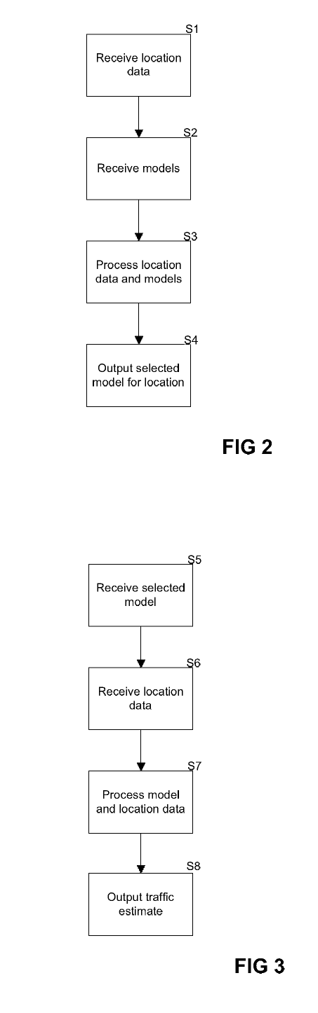

Referring now to FIG. 2, at step S1 the model selection module 1 receives location data 2a associated with the particular location for which a traffic estimate is to be determined. The location data 2a comprises, for example, an indication of whether the location is within an urban area or a rural area and an indication of the most recent measured traffic count for the location. At step S2 a plurality of models 3 are received. The plurality of models 3 comprises a model for each of a plurality of different categories of location. The different categories of location may include, for example, rural locations having a most recent measured traffic count in predetermined ranges and urban locations having a most recent measured traffic count in predetermined ranges. At step S3 the model selection module 1 processes the location data 2a and the plurality of models 3 received at steps S1 and S2 respectively and outputs a selected model 4 for the location.

Referring to FIG. 3, at step S5 the selected model output by the processing of FIG. 2 is received and at step S6 location data 2b is received. The location data 2b received at step S6 may be determined based upon the selected model received at step S5 and may include some or all of the location data 2a received at step S1 together with additional information for the location including measured traffic count data for the location. At step S7 the model received at step S5 is processed together with the location data received at step S6 and at step S8 traffic estimate 6 for the location is output.

The traffic estimate 6 provides an estimate of a traffic count at the location based upon historical measured traffic count data together with other data associated with the location. It has been found that selecting one of a plurality of models, each associated with a different category or type of location, for estimating traffic counts provides improved traffic count estimates.

As set out above, the different categories of location associated with particular models of the plurality of models may include, for example, rural locations having a most recent measured traffic count in predetermined ranges and urban locations having a most recent measured traffic count in predetermined ranges. Selection of a model for a particular location may therefore comprise determining whether the particular location is a location of type urban or type rural, and selecting one of a plurality of models associated with the determined type having a most recent measured traffic count falling within a range associated with each of the plurality of models. Locations may be defined as rural or urban for example based upon population density in an area defined relative to the location.

Each of the plurality of models uses data associated with a particular location to determine a traffic estimate for a particular location. The data will in general include historical measured traffic counts including a most recent available measured traffic count together with previous actual traffic count data including one or more previous measured traffic counts.

The data will additionally generally include population data for an area defined relative to the particular location, for example population data for an area centred on the particular location and having a predetermined radius surrounding the particular location. The population data may include current year population data including a current year population, a current year adult population and/or a current year Hispanic population. The population data may additionally include population change data including a total population change and/or an adult population change since the most recent available measured traffic count year and/or between the current year and the year of the most recent available measured traffic count and/or between the year of the most recent available measured traffic count and a year of a previous measured traffic count. The different population data may be defined for the same or different predetermined areas.

Further data that may be included in some or all of the models may include data indicating vehicle ownership in an area defined relative to the particular location. For example, the data indicating vehicle ownership may include a total number of vehicles registered to addresses within the area or an average number of vehicles per household within the area. Additionally, employment data for an area defined relative to the particular location may be included in some or all of the models. The employment data may include retail employees for the current year and/or an indication of change in retail employees between the current year and the year of the most recent available measured traffic count.

The areas defined relative to the particular location may be the same or different for each of the data. It has been found that circular areas centred on the location and having a radius in the range 0.5 miles to 20 miles provide good results.

The data for the particular location may be determined from any convenient source. For example, demographic data may be obtained from Easy Analytic Software Inc. (EASI) of New Jersey, USA. Details of the methodology used by EASI to estimate demographic data can be found at http://www.easidemographics.com/about/easiMethods.asp. Traffic count data can be obtained from traffic counts collected by State, Counties, Cities and regional planning organizations. Alternatively, traffic count data is available in a collated and normalized form from Market Planning Solutions Inc. of Tulsa, Okla.

Examples of data used to estimate traffic counts for different categories of location that have been found to provide good traffic count estimates for locations of the different categories are set out below. It will be appreciated that data for each model may vary from that indicated below. For example, data for each category may be selected based upon analysis of a training set of data.

The first to fourth predetermined numbers for which the models are defined are increasing such that the model Urban 1 is applied to urban areas with a relatively small traffic count and the model Urban 4 is applied to urban areas with a relatively high traffic count. It will be appreciated that the predetermined number of cars for which each model is defined can also be selected based upon analysis of a training set of data that has similar properties to the set of data to which the models are to be applied.

Urban 1—traffic point falls within an urban area and the count is less than a first predetermined number of cars per day

Most recent actual traffic count
Previous actual traffic count data
Current year population data
Current year auto count
Population change

Urban 2—traffic point falls within an urban area and the count is between the first predetermined number of cars per day and a second predetermined number of cars per day

Most recent actual traffic count
Previous actual traffic count data
Current year population data
Current year auto count
Current year employee data
Population change data
Employee change data

Urban 3—traffic point falls within an urban area and the count is between the second predetermined number of cars per day and a third predetermined number of cars per day

Most recent actual traffic count
Previous actual traffic count data
Current year population data
Current year auto count
Current year employee data
Population change data
Employee change data

Urban 4—traffic point falls within an urban area and the count is between the third predetermined number of cars per day and a fourth predetermined number of cars per day

Most recent actual traffic count
Previous actual traffic count
Current year population data
Current year employee data
Population change data
Employee change data

Urban 5—traffic point falls within an urban area and the count is greater than or equal to the fourth predetermined number of cars per day

Most recent actual traffic count
Previous actual traffic count data
Traffic change
Current year population data
Current year employee data
Population change data
Employee change data

Rural 1—traffic point falls within a rural area and the count is less than the first predetermined number of cars per day

Most recent actual traffic count
Previous actual traffic count data
Current year population data
Current year auto count
Population change data
Employee change data

Rural 2—traffic point falls within a rural area and the count is between the first predetermined number of cars per day and the second predetermined number of cars per day

Most recent actual traffic count
Previous actual traffic count data
Current year auto count
Current year population data
Population change data
Employee change data

Rural 3—traffic point falls within a rural area and the count is between the second predetermined number of cars per day and the third predetermined number of cars per day

Most recent actual traffic count
Previous actual traffic count data
Current year population data
Current year employees
Current year auto count
Population change data

Rural 4—traffic point falls within a rural area and the count is between the third predetermined number of cars per day and the fourth predetermined number of cars per day

Most recent actual traffic count
Previous actual traffic count data
Current year population data
Population change data
Employee change data

Rural 5—traffic point falls within a rural area and the count is greater than or equal to the fourth predetermined number of cars per day

Most recent actual traffic count
Previous actual traffic count data
Current population data
Current year employee data
Population change data
Employee change data

The data for each model can be processed in any convenient way to generate the traffic estimate. For example, a set of training data may be used to generate a plurality of weights for the data with respect to a set of weights, with each data item of each model having an associated weight of the set of weights, and the data items may be processed together with their respective weights to generate the estimate.

The above processing can be carried out to generate traffic count estimates for all locations for which data is available that allows traffic count estimation to be carried out according to the appropriate model for each particular location to generate a database of current traffic count estimates so as to provide a searchable database of location traffic indications.

It may be desirable to only estimate traffic counts for those locations for which available data is of a sufficient quality, and where data of a sufficient quality is not available for a particular location, data estimation may not be carried out for that location. For example, in some embodiments it may be desirable to exclude traffic count estimation for those locations for which the number of years between the current year and the year of the most recent available measured traffic count is greater than a predetermined number of years, for example greater than 10 years, in order to ensure traffic estimates are sufficiently reliable. Additionally or alternatively it may be desirable to exclude traffic estimation where the most recent available measured traffic count is less than a predetermined amount, for example less than 1000.

The models set out above have been used to estimate known measured traffic counts based upon previous measured traffic counts and it has been found that the above models provide a strong correlation between traffic count estimate and measured traffic count, as shown in Table 1 below.

| | MPSI Model - | | |
|---|---|---|---|
| Published Traffic | Estimated Traffic | Actual | Absolute Percent |
| Count | Count | Difference | Difference |
| 27,300 | 25,272 | −2,028 | 7.4 |
| 18,130 | 17,517 | −613 | 3.4 |
| 20,780 | 22,610 | 1,830 | 8.8 |
| 15,190 | 16,107 | 917 | 6.0 |
| 31,720 | 34,217 | 2,497 | 7.9 |
| 34,540 | 35,609 | 1,069 | 3.1 |
| 40,950 | 39,778 | −1,172 | 2.9 |
| 48,460 | 44,310 | −4,150 | 8.6 |
| 54,550 | 52,145 | −2,405 | 4.4 |
| 5,430 | 5,931 | 501 | 9.2 |
| 7,110 | 7,565 | 455 | 6.4 |
| 9,280 | 9,655 | 375 | 4.0 |
| 24,060 | 25,173 | 1,113 | 4.6 |
| 28,146 | 30,250 | 2,104 | 7.5 |
| 52,400 | 47,977 | −4,423 | 8.4 |
| 93,430 | 95,901 | 2,471 | 2.6 |
| 104,290 | 109,180 | 4,890 | 4.7 |
| 146,843 | 141,440 | −5,403 | 3.7 |
| 75,447 | 78,060 | 2,613 | 3.5 |
| 82,080 | 80,567 | −1,513 | 1.8 |

Although specific embodiments of the invention have been described above, it will be appreciated that various modifications can be made to the described embodiments without departing from the spirit and scope of the present invention. That is, the described embodiments are to be considered in all respects exemplary and non-limiting. In particular, where a particular form has been described for particular processing, it will be appreciated that such processing may be carried out in any suitable form arranged to provide suitable output data.

1. A computer-implemented method of estimating traffic data for a location, the method being implemented in a computer comprising a memory in communication with a processor, the method comprising:
receiving, as input to the processor, first data associated with the location;
selecting, by the processor, one of a plurality of models based upon the first data associated with the location;
receiving, as input to the processor, second data associated with the location; and
estimating traffic data for the location based upon the selected model and said second data.

2. A computer-implemented method according to claim 1, wherein said first data associated with the location comprises a property of the location.

3. A computer-implemented method according to claim 2, wherein said property of the location is a population density associated with the location.

4. A computer-implemented method according to claim 2, wherein said property of the location is a traffic count of the location.

5. A computer-implemented method according to claim 1, wherein selecting one of a plurality of models comprises determining whether said first data associated with the location satisfies a predetermined criterion.

6. A computer-implemented method according to claim 1, wherein said second data is selected from a plurality of data items associated with the location.

7. A computer-implemented method according to claim 6, wherein the second data is selected based upon the selected model.

8. A computer-implemented method according to claim 1, wherein said second data comprises a traffic count of the location.

9. A computer-implemented method according to claim 8, wherein said traffic count of the location is a most recent traffic count of the location.

10. A computer-implemented method according to claim 8, wherein the traffic count of the location is a historical traffic count other than a most recent traffic count of the location.

11. A computer-implemented method according to claim 1, wherein said second data comprises an indication of a population for the location.

12. A computer-implemented method according to claim 11, wherein said population data for the location comprises a change between a current year population and a previous year population.

14. A computer-implemented method according to claim 11, wherein said population is a population selected from the group consisting of: a total population; a Hispanic population; an adult population; an employed population; and a retail employee population.

15. A computer-implemented method according to claim 1, wherein said second data comprises an indication of vehicle ownership.

16. A computer-implemented method according to claim 1, wherein said second data comprises one or more data items, and the or each data item is based upon an area defined relative to said location.

17. A computer-implemented method according to claim 1, wherein the traffic data comprises an indication of a total number of vehicles passing the location in a particular time period.

18. A computer readable medium carrying a computer program comprising computer readable instructions configured to cause a computer to carry out a method according to claim 1.

19. A computer apparatus for estimating traffic data for a location, the apparatus comprising:
a memory storing processor readable instructions; and
a processor arranged to read and execute instructions stored in said memory;
wherein said processor readable instructions comprise instructions arranged to control the computer to carry out a method according to claim 1.
